(19) United States
(12) Patent Application Publication
(10) Pub. No.: US 2017/0061179 A1
(43) Pub. Date: Mar. 2, 2017

(54) ASSIGNMENT DEVICE AND METHOD FOR SORTING LUGGAGE PIECES

(71) Applicant: SIEMENS AKTIENGESELLSCHAFT, MUENCHEN (DE)

(72) Inventors: SVETLOZAR DELIANSKI, BERLIN (DE); BENGT MUECK, DETMOLD (DE); JOERG ROTTLAND, RADOLFZELL (DE)

(21) Appl. No.: 14/933,194

(22) Filed: Nov. 5, 2015

(30) Foreign Application Priority Data
Aug. 26, 2015 (DE) 202015006102.8

(51) Int. Cl. G06K 7/10; G06K 9/32

(52) U.S. Cl. CPC G06K 7/10821; G06K 9/3216; G06K 2019/06243

(57) ABSTRACT

Assignment device for the sorting of luggage pieces according to a sorting criterion includes a coding station and a processing station. A non-machine readable sorting criterion can be assigned at the processing station. The assignment is effected in that an image of the luggage enabling the assignment can be transmitted to the processing station. A method for sorting luggage pieces according to a sorting criterion includes a step of relaying an image of a luggage piece to the processing.

### CROSS-REFERENCE TO RELATED APPLICATION

This application claims the priority, under 35 U.S.C. §119, of German application DE 20 2015 006 102.8, filed Aug. 26, 2015; the prior application is herewith incorporated by reference in its entirety.

### BACKGROUND OF THE INVENTION

### Field of the Invention

The invention pertains to the technical field of luggage handling at airports.

Airport luggage handling systems transport and sort luggage pieces. For this, the luggage pieces are pro-vided with a luggage tag with a sorting criterion, containing at least the destination airport, the flight and a luggage number in human readable text. In addition, the luggage number is coded in a machine readable barcode. In order to sort a luggage automatically at a coding station, the luggage tag is read by machine.

When the sorting criterion of a piece of luggage is not machine readable, it is taken to a manual work station and manually coded there. This requires a direct contact of the work force with the luggage. If the manual workstations are situated close to the coding stations, they are subject to a fluctuating load and the personnel cannot have a uniform workload. Centralized manual workstations allow a more uniform workload of the personnel, but an additional burden on the luggage handling system is caused by the transport between coding station and manual work station. This results in increased transport times especially for those luggage pieces whose transport is already time-critical due to a required manual coding. It therefore becomes probable that these very luggage pieces will not be read out and sorted in a timely manner.

### SUMMARY OF THE INVENTION

It is accordingly an object of the invention to provide an apparatus and a method for remotely reading luggage pieces which overcomes the above-mentioned and other disadvantages of the heretofore-known devices and methods of this general type and which provides for a quick sorting of especially the luggage pieces with non-machine readable sorting criterion and at the same time with slight additional burden on the luggage handling system.

With the foregoing and other objects in view there is provided, in accordance with the invention, an assignment device for sorting luggage pieces according to a sorting criterion, the assignment device comprising:

a coding station; and

a processing station, wherein a non-machine readable sorting criterion is assignable at said processing station, and wherein an assignment is effected by transmitting an image of a luggage piece enabling the assignment to the processing station.

In other words, the solution according to the invention calls for an assignment device for the sorting of luggage pieces according to a sorting criterion, comprising a coding station and a processing station, wherein a non-machine readable sorting criterion can be assigned at the processing station. The assigning is done in that an image of the luggage enabling the assignment can be transmitted to the processing station.

In order to bundle the assignment tasks, according to one preferred embodiment the assignment can be done in centralized manner.

According to one advantageous embodiment, in order to read out and sort the luggage pieces without direct contact with the coding station the sorting criterion can be read out at the processing station by means of an image of the luggage.

According to another embodiment, in order to make possible a commonplace technical solution, which can be implemented without problems, for obtaining the image, the image of the luggage can be taken by a camera system.

According to one embodiment, an attempt at a classification can be done with the help of a text recognition system. If this is successful, the remaining labor expense becomes less and fewer personnel are needed for the reading.

In order to make possible the slightest possible additional transport distances and times, according to another advantageous embodiment the coding station is disposed in physical proximity to that position where the sorting of the luggage pieces at first occurs.

According to an embodiment of the invention, in order to achieve a uniform workload of the processing station, one or more processing stations can be assigned to one or more coding stations. Furthermore, in this way only a onetime technical outfitting of the one processing station is required.

According to an advantageous embodiment, the processing station can comprise a human-machine interface. This enables a manual entry of the sorting criterion read off from the image to the processing station by a human assignment operator.

With the above and other objects in view there is also provided, in accordance with the invention, a method for the sorting luggage pieces according to a sorting criterion with an assignment device, including a coding station and a processing station, wherein a non-machine readable sorting criterion can be assigned at the processing station. The method comprises the step of a relaying of an image of the luggage to the processing station.

According to one embodiment, a sorting of the luggage can be done with the aid of the assignment device upon failed machine reading at the coding station. In this way, the assignment device is under the least possible burden and it can be used for other coding stations, since a sorting is only done for a failed machine reading. Furthermore, the luggage for the sorting need not be transported to the processing station, but instead can be sorted with no additional transport and thus with no additional burden on the luggage handling system directly at the coding station.

In order to make possible a manual reading, according to one embodiment an assignment worker can read out the sorting criterion at the processing station.

In accordance with a concomitant feature of the invention, in order to keep as low as possible the expense for the sorting with the help of the assignment device, a manual assignment can be done only for a failed assignment at the processing station.

Other features which are considered as characteristic for the invention are set forth in the appended claims.

Although the invention is illustrated and described herein as embodied in a remote reading of luggage, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a segment of a luggage handling system with an assignment device according to the invention; and

FIG. 2 is a flow chart for the operation of the assignment device shown in FIG. 1.

### DETAILED DESCRIPTION OF THE INVENTION

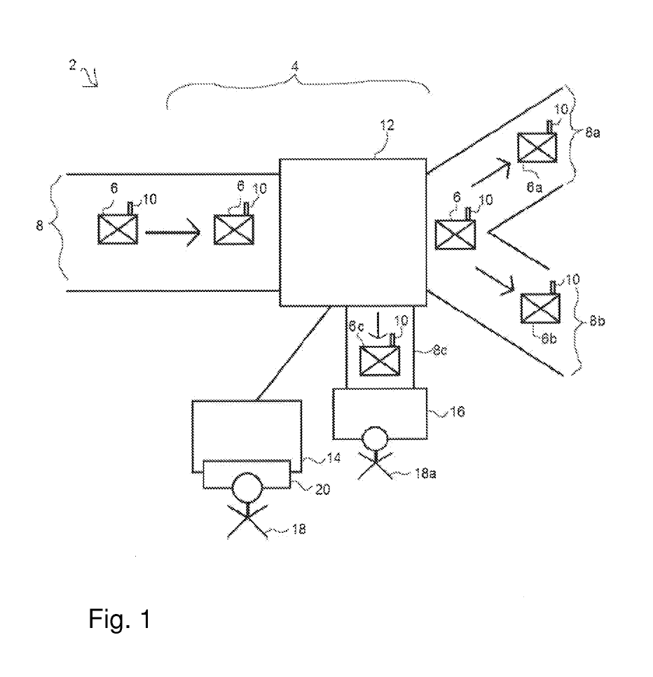

Referring now to the figures of the drawing in detail and first, particularly, to FIG. 1 thereof, there is shown a schematic view of a segment of an airport luggage handling system 2 with an assignment device 4 according to one preferred sample embodiment of the invention. The luggage handling system 2 is suitable for the transport of suitcases, bags, knapsacks and other goods which shall be called collectively hereafter luggage pieces 6, on a conveyor line 8, which can be configured as a conveyor belt.

The luggage pieces 6 are marked each time with a luggage tag 10, which contains as sorting criterion at least one destination airport, a flight number and a luggage number in human readable text, as well as machine readable barcode. The luggage 6 passes through a coding station 12 before it is sorted onto one of the two conveyor lines 8a, 8b depending on the sorting criterion. The coding station 12, like a processing station 14 and a manual work station 16 for the coding, is also part of the assignment device 4.

The coding station 12 is arranged in direct physical proximity to the position at which the sorting of the luggage first occurs. Thus, the luggage 6 need not travel any additional unnecessary distance in the luggage handling system 2. Furthermore, the risk of a wrong sorting when the sorting criterion was at first correctly assigned is greatly reduced by the physical proximity. The coding station 12 here is even located directly along a transport path of the luggage pieces 6, so that a passing through the coding station 12 involves no additional distances or transport times.

If after a failed reading of the sorting criterion at the processing station 14 of the assignment device 12 a manual coding should be needed at the manual work station 16, making possible a direct contact between operator 18a and luggage 6, the luggage 6 can then be sorted with very short transport distance directly onto one of the two conveyor belts 8a, 8b. Short transport distances and consequently only slight additional transport times are advantageous, since these hardly causes any additional burden on the luggage handling system 2.

The assignment device enables a reading of the sorting criterion even when the initially performed machine scan was not successful. The assignment occurs at the coding station 12, while the non-machine readable sorting criterion can be assigned at the processing station 14. In this way, the assignment device 4 is under the least possible strain and can be used for other coding stations 12, since a sorting of the luggage 6 is done only upon failed machine reading. Furthermore, the luggage 6 need not be transported to the processing station 14 for the sorting, but instead can be sorted with no additional transport directly at the coding station 12. Several coding stations 12 and a processing station 14 can be linked together so that the assignment is done by transmitting an image of the luggage, making possible the assignment, to the processing station 14. Therefore, no direct physical contact with the processing station 14 and an operator 18 in attendance there via a human-machine interface 20 as a user interface is required for the assignment. The image will be one or more photos, but also video recordings of the luggage and other forms of imaging of the luggage 6 are possible.

Since only a luggage tag 10 is secured to the luggage 6 and this must be visible and recognizable in the images for the assignment, it is advantageous to take a panoramic image of the luggage consisting of several single pieces. This is possible, for example, with a camera system, which comprises a layout in the form of a frame erected around the conveyor means, on which a certain number of cameras are fastened and aimed, the number being dependent on an angular resolution of the cameras and their own resolution. With the cameras and luggage dimensions of today, a cubic volume of around 2.5 m3 is sensible and adequate, comprising six cameras arranged on top, two cameras arranged at the side, and possibly one camera aimed upward from underneath. Side walls of the conveyor means may have to be removed in part in order to enable an unobstructed view of the luggage 6 and its luggage tag 10.

After taking the image, the sorting criterion can be read at the processing station 14 with the help of the image of the luggage. For this, the image of the luggage was at first relayed to the processing station 14. This enables a quick sorting of the luggage at the processing station 14 with no additional burden on the luggage handling system 2. Luggage 6 and processing station 14 thus need not be close together and the assignment is done in centralized manner. As a result, the labor cost of the operator 18 can be better estimated; in addition, the operator 18 saves time which he otherwise would have spent on distances. In order to perform the reading with the least possible labor expense for the operator 18, at first an attempt is made to assign the sorting criterion at the processing station 14 by means of the image with an optical text recognition system. The least possible labor expense for the operator 18 and thus for the sorting with the help of the assignment device 4 is also ensured in that a manual assignment is only done for failed assignment at the processing station 14. The manual assignment encompasses all the assignment attempts in which an operator 18 is involved. Said operator 18 as an assignment worker 18 can read out the sorting criterion at the processing station 14 and thus make possible a manual reading, or he can determine the sorting criterion as an assignment worker 18a at the manual work station 16. The operator 18 enters the sorting criterion into the processing station 14 via a human-machine interface 20, which is part of the processing station 14 or attached to it.

The determination of the sorting criterion is a time-critical affair, due to departure times, transfer times, and passengers who want to receive their luggage pieces as soon as possible. At the same time, however, the labor time of the operator 18 is expensive. Yet idle stand around time is always to be avoided, especially due to all the above-mentioned aspects. An assignment of one or more processing stations 14 and one or more coding stations 12 enables a quite good balance between a uniform workload of the operator 18, on the one hand, and a very prompt processing of the luggage 6, i.e., the assigning of the sorting criterion. An additional benefit of only one processing station is that the operator 18 can make assignments during the time he would otherwise have to spend walking between the coding stations. Now, such walking occurs only if the assignment at the processing station fails.

The processing station 14 receives as input both the images of the luggage pieces and information contained in the Airport Operational Database (AODB), so that a prioritization of the assignment of the sorting criterion can be done according to urgency or other criteria, and these criteria can be extracted from the information contained in the AODB. A matching up of non-machine readable sorting criteria with as yet unassigned luggage pieces 6 can greatly facilitate the assignment in the case of illegible and/or only partly recognizable luggage tags 10.

For a certain time, such as for as long as the particular luggage 6 still finds itself in the luggage handling system 2, all images or only selected images will be kept in a central archive. This enables a match-up at a later time and is especially advisable if a reassignment of the sorting criterion is to be done at a later time at another position of the luggage handling system 2.

The coding at the coding station 12 is done without physical contact of another operator 18a with the luggage 6. At a later time, said luggage 6 can be identified based on its position in the system, for example, by a known time lag.

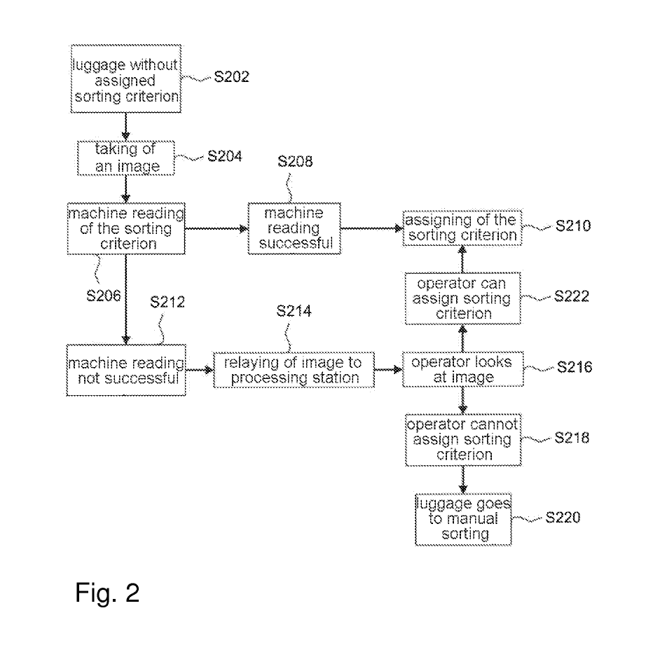

FIG. 2 shows a flow chart for the operation of the assignment device 4 shown in FIG. 1 according to a preferred embodiment of the invention. Prior to a reading attempt at the coding station 12, the luggage 6 is without an assigned sorting criterion S202. In order to determine the sorting criterion, an image is taken S204 and then a machine reading of the sorting criterion S206 is done. If the machine reading is successful S208, the sorting criterion S210 is assigned to the luggage 6. If the machine reading is not successful S212, the image is relayed to the processing station 12 S214.

The operator 18 of the processing station 14 looks at the image S216 in order to assign the sorting criterion. If the operator 18 cannot assign the sorting criterion S218, the luggage 6 moves on to manual sorting 220 at the manual work station 16. If the operator 18 can assign the sorting criterion S222, an assignment of the sorting criterion S210 occurs at the coding station 12 just as with a successful machine reading S208.

The machine reading can occur as described above with the help of the taking of an image S204, only at the processing station 14 or directly at the coding station 12 on the luggage 6 itself, for example, with a laser scanner. Optionally, the relayed image can be read at the processing station 14 with the help of an optical text recognition system, before the operator 18 looks at the image.

1. An assignment device for sorting luggage pieces according to a sorting criterion, the assignment device comprising:
a coding station; and
a processing station, wherein a non-machine readable sorting criterion is assignable at said processing station, and wherein an assignment is effected by transmitting an image of a luggage piece enabling the assignment to the processing station.

2. The assignment device according to claim 1, wherein the assignment is done in a centralized manner.

3. The assignment device according to claim 1, wherein the sorting criterion is read out at said processing station by way of an image of the luggage piece.

4. The assignment device according to claim 3, which comprises a camera system configured to take the image of the luggage piece.

5. The assignment device according to claim 1, which comprises a text recognition system configured to help with attempting a classification.

6. The assignment device according to claim 1, wherein said coding station is disposed in physical proximity to a position where the sorting of the luggage pieces first occurs.

7. The assignment device according to claim 1, wherein said processing station is one or more processing stations assigned to one or more said coding stations.

8. The assignment device according to claim 1, wherein said processing station comprises a human-machine interface.

9. A method for sorting luggage pieces according to a sorting criterion by way of an assignment device including a coding station and a processing station, the method comprising: assigning a non-machine readable sorting criterion at the processing station and relaying an image of a luggage piece to the processing.

10. The method according to claim 9, which comprises sorting the luggage piece with the aid of the assignment device upon failed machine reading at the coding station.

11. The method according to claim 9, which comprises reading out the sorting criterion by an assignment worker at the processing station.

12. The method according to claim 9, which comprises effecting a manual assignment only for a failed assignment at the processing station.
